(19) United States
(12) Patent Application Publication
(10) Pub. No.: US 2011/0259085 A1
(43) Pub. Date: Oct. 27, 2011

(54) Device and Method for Measuring the Water Permeability of a Material

(75) Inventor: Giovanni Cristini, Marone (IT)

(73) Assignee: S.A.GUISEPPE GRISTINI S.P.A., Milan (IT)

(21) Appl. No.: 13/121,280

(22) PCT Filed: Sep. 25, 2009
(86) PCT No.: PCT/IB2009/006936

§ 371 Date: Jul. 12, 2011

(30) Foreign Application Priority Data
Sep. 26, 2008 (IT) MI2008A001711

(51) Int. Cl. G01N 15/08

(52) U.S. Cl. 73/38

(57) ABSTRACT

A device for measuring the water permeability of a material (2) moving along a determinate travelling direction (D) is provided with a nozzle (5), through which a determined water flow (Pu) flows for impinging a surface portion (9) of the material (2); and with first and second reading heads (6a, βb) of a parameter indicative of the quantity of water present in the material (2) arranged upstream and downstream of the nozzle (5) along the travelling direction (D) of the material (2), respectively.

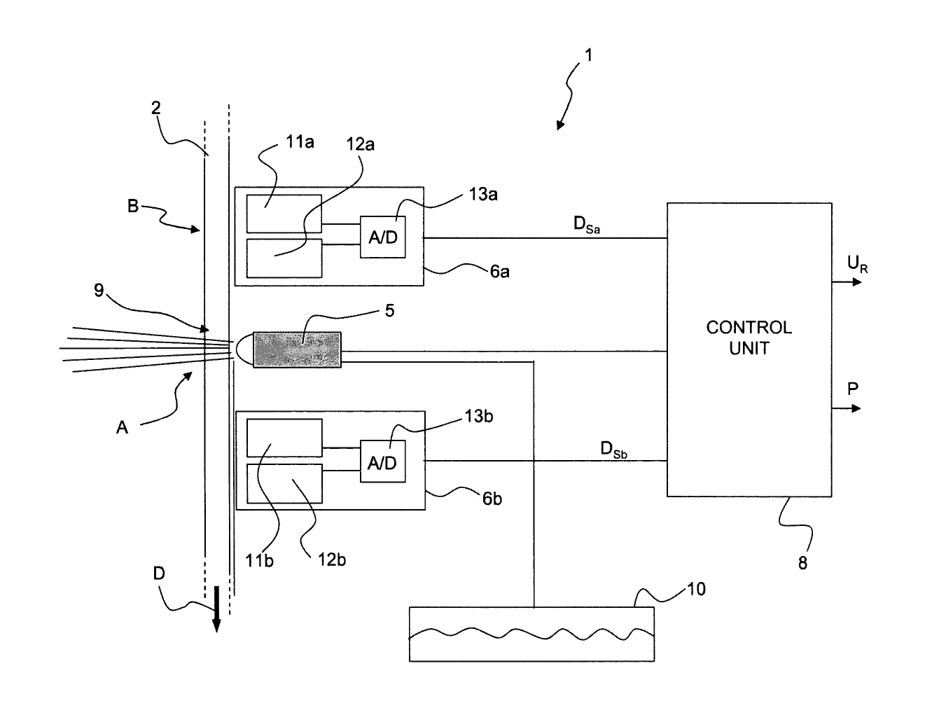

### TECHNICAL FIELD

The present invention relates to a device and method for measuring the water permeability of a material.

In particular, the present invention relates to a device and method for measuring the water permeability of a felt moving in the pressing section of a paper mill machine.

### BACKGROUND ART

It is known that in a paper mill machine, a layer of cellulose pulp made of about 3% of fiber and mineral fillers and of about 97% of water, is fed along a paper production path which crosses in sequence a draining section of the pulp layer which originates a sheet of paper, a pressing section of the sheet of paper thus formed and a drying section of the sheet of paper.

A first portion of the production path which crosses the draining section defines a draining path, along which the layer of cellulose pulp travels laid on a turning loop of fabric, commonly named “forming fabric”, held taut and guided by appropriate cylinders. A plurality of suction units and a plurality of foils adapted to remove the water from the pulp during the travel of the fabric, by suction and by removal respectively, are arranged under the fabric at a regular distance from one another.

A second portion of the production path which crosses the pressing section defines a pressing path, along which the sheet from the draining section, which is consolidated but still very moist, passes through a series of longitudinally overlaying cylinders pressed against one another, named “presses”, which have the task of dehydrating the consolidated sheet. Each cylinder is coated with a loop of fabric, commonly named “press felt” or simply “felt”, held taut and guided by appropriate cylinders. The felt is normally made of a fabric consisting of a base structure coated with layers of synthetic nappa.

A high efficiency of the pressing section reduces the cost of the treatment carried out by the drying section downstream of the pressing section. Furthermore, it is very important for the sheet to be uniformly dehydrated to prevent lack of homogeneity of the sheet.

For this purpose, devices for controlling the water permeability of felts exist on the market. The permeability of felts is indeed of fundamental importance because felts having uneven permeability may originate lack of homogeneity of the generated sheet and thus worsen the quality of the sheet itself. In sheet manufacturing, the average felt permeability value is also important, in addition to its homogeneity. Indeed, in use, felts tend to be compacted by the action of the presses and get clogged up by the substances released by the sheet of paper. These factors may cause a considerable reduction of the water absorption capacity by the felt, and thus a reduction of the working efficiency of the felt itself, to the extent that its replacement is required.

Devices for measuring the water permeability of felts are known, the devices comprising a nozzle, which rests on the material to be analyzed and through which water and/or a mixture of water and air kept at constant flow flows. Water permeability of the material under examination is calculated according to the pressure value detected inside the nozzle.

This type of device for measuring the water permeability of a material does not always provide, however, reliable analysis data representative of the water permeability state of the felt, and is especially influenced by the quantity of water contained by the felt before measuring permeability, in addition to the speed of the felt itself.

Furthermore, another felt-related parameter (i.e. residual humidity) needs to be measured. Indeed, this parameter contributes to deriving analysis data representative of the felt state.

### DISCLOSURE OF INVENTION

It is an object of the present invention to provide a device for measuring the water permeability of a material which is free from the drawbacks of the prior art hereto illustrated; in particular, it is an object of the invention to provide a device for measuring the water permeability of a material which is reliable and easy and cost-effective to be implemented. Furthermore, it is an object of the present invention to provide a device for measuring the water permeability of a material which is able to determine the residual humidity of the material under examination at the same time.

In accordance with these objects, the present invention relates to a device for measuring the water permeability of a material moving along a determinate travelling direction; the device comprising a nozzle through which a determinate water flow flows for impinging a surface portion of the material; the device being characterized in that it comprises first and second reading heads of a parameter indicative of the quantity of water present in the material arranged upstream and downstream of the nozzle along the travelling direction of the material, respectively.

It is a further object of the present invention to provide a method for measuring the water permeability of a material moving along a determinate travelling direction as claimed in claim 12.

### BRIEF DESCRIPTION OF THE DRAWING

Further features and advantages of the present invention will be apparent from the following description of a non-limitative example thereof, with reference to the enclosed FIGURE, which is a diagrammatic view of a device for measuring the water permeability of a material according to the present invention.

### BEST MODE FOR CARRYING OUT THE INVENTION

In the FIGURE, numeral 1 indicates a device for measuring the water permeability of a material 2 moving along a determinate travelling direction D which, according to the applications of device 1, may be curved, rectilinear, etc.

Hereinafter, the term “permeability” will indicate the quantity of water absorbed by the material under examination in the unit of time.

In particular, hereinafter, there will be described by way of non-limitative example a device 1 for measuring the water permeability of a felt 2 of a press for a paper mill machine (not shown in the accompanying figures), which is rotationally fed by the press in a determined travelling direction D and at a substantially constant velocity V_{F}.

It is understood that device 1 may be alternatively used for measuring the water permeability of other materials, e.g. of a forming fabric in the paper mill machine.

Device 1 comprises a nozzle 5, a first reading head 6a and a second reading head 6b, and a control unit 8. The nozzle 5 is arranged in a first position A along the travelling direction D, the first reading head 6a is arranged in a second position B upstream of the first position A along the travelling direction D and the second reading head is arranged downstream of the first position A along the travelling direction D.

Nozzle 5 faces a surface portion 9 of the felt 2 and is arranged very close to felt 2, while the reading heads 6a and 6b are arranged substantially in contact with felt 2.

In particular, nozzle 5 is connected to a water source, e.g. a tank 10, and generates a jet of water with a flow P_{U} which impinges the surface portion 9 at constant pressure and under the control of the control unit 8. The water flow P_{U} of the nozzle is preferably mixed with air. The diameter of the nozzle 5 may vary from about 0.5 to 5 mm.

The reading heads 6a and 6b comprise respective microwave sensors 11a and 11b, respective temperature sensors 12a and 12b for determining the temperature of the felt 2, and respective A/D analog-digital converters 13a and 13b.

Each microwave sensor 11a, 11b comprises a microwave transmitter and a microwave receiver (known and not shown for simplicity in the accompanying FIGURE) for sending a signal onto the felt 2 and detecting a response to the signal, respectively. In particular, each microwave sensor 11a and 11b comprises a resonator circuit characterized by a frequency response curve substantially centered about a resonance frequency, at which there is a minimum amplitude value.

In the non-limitative example described and illustrated here, the resonator circuit of the microwave sensors 11a and 11b is of the slit type. Such a resonator circuit may be made by means of a third order Hilbert's curve and connected to a micro-strip transmission line by means of electromagnetic coupling or may be made by means of fractal type geometries coupled to a planar transmission line by means of electromagnetic coupling. It is understood that microwaves sensors of different type may be used.

The presence of a material, in this case of felt 2, close to the microwave sensors 11a and 11b modifies the frequency response curve of the resonator circuit, in terms of displacement of the resonance frequency and thus of the minimum amplitude variation, in a manner which depends on the physical features of the material itself. This resonance frequency variation of the resonator circuit is substantially linked to the dielectric constant of the analyzed material; therefore, for a given dielectric constant, the variation of the resonance frequency is linked to the thickness of the material and to other chemical-physical features either directly or indirectly linked to the dialectic constant. For example, each microwave sensor 11a and 11b of the reading heads 6a and 6b is able to indirectly determine the water content of felt 2. In particular, each microwave sensor 11a and 11b is able to provide a water surface density value D_{Sa} and D_{Sb} related to the surface portion of felt 2 facing the respective microwave sensor 11a and 11b in the moment in which the measurement is carried out.

Each A/D converter 13a and 13b converts analog signals from the respective microwave sensor 11a and 11b and from the respective temperature sensor 12a and 12b into digital signals.

In addition to controlling the operation of the reading heads 6a and 6b and of nozzle 5, the control unit 8 comprises calculation means of a residual humidity value U_{R} of felt 2 and calculation means of a permeability value P of felt 2 based on water surface density values D_{Sa} and D_{Sb} detected by the reading heads 6a and 6b considering the velocity V_{F} of felt 2.

Furthermore, the control unit 8 stores and displays the residual humidity U_{R} and permeability P values, e.g. on a display (not shown in the accompanying figures). Moreover, the control unit 8 may also indicate faults by displaying warning messages or by activating alarm signals.

The operation of the device 1 implementing the method for measuring the water permeability P of the material 2 according to the present invention is as follows.

Once device 1 has been set up, and specifically the nozzle 5 and the first and second reading heads 6a and 6b, upstream and downstream of nozzle 5 along the travelling direction D of the material 2, respectively, the water surface density D_{Sa} present in felt 2 is measured by the first reading head 6a upstream of nozzle 5.

A determined water flow P_{U} is thus sprayed on the surface portion 9 of felt 2 by nozzle 5 and the water surface density D_{Sb} is measured on the surface portion 9 of felt 2 by the second reading head 6b, downstream of nozzle 5; in particular, the water surface density value D_{Sb} is detected in the moment in which the surface portion 9, previously sprayed with the jet of water, passes under the second reading head 6b. The second reading head 6b is activated by the control unit 8, which takes into account the velocity V_{F} of felt 2.

A residual humidity value U_{R} of felt 2 and a permeability value P of felt 2 are then calculated by the control unit 8 from the measurements of the water surface density D_{Sa} and D_{Sb}.

In particular, the residual humidity value U_{R} of felt 2 is calculated according to the water surface density D_{Sb} detected by the second reading head.

The permeability P is calculated according to the difference between the water content of felt 2 determined before and after the jet of water is sprayed by nozzle 5.

In particular, the permeability value P of felt 2 is substantially calculated by applying the following formula:

P=(D_{Sa}−D_{Sb})·V_{S}

where:

D_{Sa} is the water surface density value detected by the first reading head 6a expressed in g/m²;

D_{Sb} is the water surface density value detected by the second reading head 6b expressed in g/m²; and

V_{S} is a function of the velocity V_{F} of felt 2 and of the greater width from among the width of the surface portion 9 of felt 2 facing the nozzle 5 and the widths of the surface portions of felt 2 facing the microwave sensors 11a and 11b, where “width” means the measurement along a direction which is transversal to the travelling direction D of felt 2.

In particular:

V_{S}=V_{F}·L

Where:

V_{F} is the velocity of the felt in m/min;

L is the greater width from among the width of the surface portion 9 of felt 2 facing the nozzle 5 and the widths of the surface portions of felt 2 facing the microwave sensors 11a and 11b.

The resolution of the microwave sensors 11a and 11b is also appropriately selected according to the velocity V_{F} of felt 2 (the higher the velocity V_{F} envisaged in use, the higher the resolution of the microwave sensors 11a and 11b to obtain accurate measurement data).

The used microwave sensors 11a and 11b preferably have a resolution from about 0.5 to about 20 g/m².

Device 1 advantageously allows to integrate two measurements (residual humidity U_{R} and permeability P) in one apparatus. Furthermore, the two measures are correlated in time and position, because they are carried out at the same time. This allows to derive reliable analysis data representative of the operating state of felt 2 and this further results in evident advantages in terms of costs and manipulation handiness of device 1.

It is finally apparent that changes and variations may be made to the device and method described herein without departing from the scope of the appended claims.

1. A device for measuring the water permeability of a material (2) moving along a determinate travelling direction (D); the device (1) comprising a nozzle (5), arranged in a first position (A) along the travelling direction (D) and through which a determinate water flow (P_{U}) flows for impinging a surface portion (9) of the material (2); the device (1) being characterized in that it comprises a first and a second reading head (6a, 6b) of a first and a second parameter (D_{Sa}, D_{Sb}) indicative of the quantity of water present in the material (2); the first reading head (6a) being arranged in a second position (B) arranged upstream of the nozzle (5) along the travelling direction (D), and the second reading head (6b) being arranged in the first position (A) or downstream of the first position (A) along the travelling direction (D).

2. A device according to claim 1, characterized in that the first and the second reading head (6a, 6b) are adapted to detect a water surface density (D_{Sa}, D_{Sb}) of the material (2).

3. A device according to claim 1, characterized in that the first and the second reading head (6a, 6b) comprise respective microwave sensors (11a, 11b) for measuring the first and the second parameter indicative of the quantity of water (D_{Sa}, D_{Sb}) present in the material (2).

4. A device according to claim 3, characterized in that the first and the second reading head (6a, 6b) comprise respective temperature sensors (12a, 12b) for measuring the temperature of the material (2).

5. A device according to claim 4, characterized in that the first and the second reading head (6a, 6b) comprise respective A/D converters (13a, 13b).

6. A device according to claim 5, characterized in that the A/D converter (13a, 13b) of each reading head (6a, 6b) is connected with the respective microwave sensor (11a, 11b) and with the respective temperature sensor (12a, 12b).

7. A device according to claim 1, characterized in that the reading heads (6a, 6b) are arranged substantially in contact with the material (2).

8. A device according to claim 1, characterized in that it comprises a control unit (8), which is coupled to the reading heads (6a, 6b) and to the nozzle (5) and controls the reading heads (6a, 6b) and the nozzle (5).

9. A device according to claim 8, characterized in that the control unit (8) comprises means for calculating the residual humidity (U_{R}) of the material (2) on the basis of the second parameter indicative of the quantity of water (D_{Sb}) present in the material (2).

10. A device according to claim 8, characterized in that the control unit (8) comprises means for calculating the water permeability (P) of the material (2) on the basis of the first and the second parameter indicative of the quantity of water (D_{Sa}, D_{Sb}) present in the material (2).

11. A device according to claim 1, characterized in that the water flow (P_{U}) supplied by the nozzle (5) is mixed with air.

12. A method for measuring the water permeability of a material (2) moving along a determinate travelling direction (D) and at constant velocity (V_{F}); the method comprising the steps of:
arranging a supply nozzle (5) of a water flow (P_{U}) a first position (A) along the travelling direction (D) and arranging a first reading head (6a) of a first parameter (D_{Sa}) indicative of the quantity of water present in the material (2) in a second position (B) upstream of the first position (A) along the travelling direction (D) or the material (2) and arranging a second reading head (6b) of a second parameter (D_{Sb}) indicative of the quantity of water present in the material (2) in the first position (A) or downstream of the first position (A) along the travelling direction (D) of the material (2);
measuring the first parameter (D_{Sa}) indicative of the quantity of water present in the material (2) by means of the first reading head (6a);
spraying a determinate water flow (P_{U}) on a surface portion (9) of the material (2) by means of the nozzle (5);
measuring the second parameter (D_{Sb}) indicative of the quantity of water present in the surface portion (9) of the material (2) by means of the second reading head (6b); and
calculating a water permeability value (P) of the material (2) starting from the measurements of the first parameter (D_{Sa}) and the second parameter (D_{Sb}) indicative of the quantity of water contained in the material (2).

13. A method according to claim 12, characterized in that the steps of measuring the first parameter (D_{Sa}) and the second parameter (D_{Sb}) indicative of the quantity of water respectively comprise a step of detecting, by means of microwave sensors (11a, 11b) comprised in the reading heads (6a, 6b), the water surface density (D_{Sa}, D_{Sb}) in the material (2).

14. A method according to claim 12, characterized by comprising the step of calculating a residual humidity value (U_{R}) of the material (2) on the basis of the second parameter (D_{Sb}) indicative of the quantity of water present in the material (2).

15. A method according to claim 12, characterized by calculating the permeability value (P) of the material (2) by means of the formula:
P=(D_{Sa}−D_{Sb})·V_{S}
where:
D_{Sa} is the first parameter indicative of the quantity of water present in the material (2) detected by means of the first reading head (6a);
D_{Sb} is the second parameter indicative of the quantity of water present in the material (2) detected by means of the second reading head (6b); and
V_{S} is a function of the velocity (V_{F}) of the material (2) and of the greater width from among the width of the surface portion (9) of the material (2) facing the nozzle (5) and the widths of the surface portions of the material (2) facing the first and the second reading head (6a, 6b), where by ‘width’ it is intended the measurement along a direction transverse to the travelling direction (D) of the material (2).
